(19) United States
(12) Patent Application Publication
(10) Pub. No.: US 2004/0093614 A1
(43) Pub. Date: May 13, 2004

(54) Conditional access system and receiver

(76) Inventors: Atsunori Sakurai, Osaka-shi (JP); Tetsuya Inoue, Ibaraki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/694,346

(22) Filed: Oct. 28, 2003

(30) Foreign Application Priority Data
Oct. 29, 2002 (JP) 2002-313904

(51) Int. Cl. H04N 7/20; H04N 7/16

(52) U.S. Cl. 725/25; 725/68

(57) ABSTRACT

A conditional access system comprising: a HITS station 101 for transmitting a content to which only a receiver under contract for satellite TV subscriptions can have an access; a plurality of CATV stations 106a or the like for receiving and retransmitting the content transmitted from the HITS station 101; a receiver 112 for receiving the content retransmitted from the CATV station 106a, or the like. The receiver 112 includes: a storage unit 116 for storing a CATV station identifier for identifying the CATV station 106a with which the receiver 112 is under contract for satellite TV subscriptions, or the like; a cable modem 114 for receiving the CATV station identifier transmitted from the CATV station 106a or the like, judging whether or not the received CATV station identifier and the CATV station identifier stored in the storage unit 116 match, and transmitting, to the HITS station 101, relocation-between-stations information including a receiver identifier of the receiver 112 as well as the received CATV station identifier when judging that they do not match; and a CPU 115, and the like.

### BACKGROUND OF THE INVENTION

1. Field of the Invention

The present invention relates to a conditional access system for a content distribution made via a cable TV or the like, especially to techniques for urging a user to sign up for satellite TV subscriptions when a receiver is relocated between CATV stations, or the like.

2. Description of the Related Art

Under the CATV system, a plurality of CATV stations receive a content transmitted via satellite from the same content provider and each of the CATV stations distributes the content for the user who has signed up for satellite TV subscriptions with the local CATV station. For charged contents, the content provider broadcasts it via satellite after changing it into an encrypted content that is available for the user who has signed up for the subscription and each of the CATV stations retransmits the received encrypted content to the user by using a conditional access function. Thus, under the management of the content provider, the conditional access for the charged contents is operated.

In this way, the processing for the conditional access is operated not by each CATV station but by the content provider, therefore, when the user moved from an operation area of the first CATV station to that of the second CATV station, it is possible, in principle, to view the charged contents with the same receiver even in the operation area of the second CATV station although the user has signed up only with the first CATV station. Namely, it is possible to use the charged contents distributed by the second CATV station without the subscription to the second CATV station.

Conventionally, in order to prevent such unauthorized relocation of the receiver between the CATV stations, the receiver relocated from one CATV to the other without authorization shall not be able to use the contents at all the channels by adopting a usage control system for transmodulation at each CATV station (for instance, “Japanese Cable Laboratories specification BS digital broadcasting transmodulation operation specification JCL SPEC-001 1.0 version” JCTA Japan Cable Laboratories, Oct. 28, 2000 (see reference to Chapter 4 ‘Use control function’, pp 13).

In this system, the receiver stores an identifier of the CATV station transmitted from the CATV station with which the user has signed up, and when an identifier of a different CATV station is transmitted after the relocation, the receiver detects the relocation by comparing the received identifier and the identifier that is already stored so as not to receive the content distributed from the CATV station in the area to which it is relocated. Thus, the unauthorized relocation can be prevented.

However, the problem is that the CATV station can neither grasp that the receiver is relocated without authorization nor urge the new receiver to sign up with the CATV station in the area to which the receiver is relocated, while the existing technique can be a deterrent against the unauthorized relocation.

### SUMMARY OF THE INVENTION

The present invention is conceived to solve the above problems and aims to provide a conditional access system which can prevent the unauthorized relocation of a receiver between the CATV stations and promote subscriptions to the CATV station in the area to which the receiver is relocated.

In order to achieve the above object, the conditional access system according to the present invention comprises: a content providing apparatus for transmitting a content to which only a receiver under contract for satellite TV subscriptions can have an access; a plurality of relay stations for receiving and retransmitting the content transmitted from the content providing apparatus; and a receiver for receiving the content retransmitted from one of the plurality of relay stations, wherein the receiver includes: a station identifier holding unit operable to hold a station identifier for identifying the relay station with which the receiver is under the contract for satellite TV subscriptions; a station identifier reception unit operable to receive a station identifier transmitted from the relay station; a judgment unit operable to judge whether or not the received station identifier and the station identifier held in the station identifier holding unit match; and a relocation-between-stations information transmission unit operable to transmit relocation-between-stations information to the content providing apparatus, when the judgment unit judges that the received station identifier and the station identifier held in the station identifier holding unit do not match, said relocation-between-stations information including a receiver identifier which identifies the receiver.

Here, for example, the relocation-between-stations information transmission unit transmits, to the relay station, the relocation-between-stations information addressed to the content providing apparatus, said relocation-between-stations information including, in addition to the receiver identifier, the station identifier received by the station identifier reception unit, and the relay station receives the relocation-between-stations information addressed to the content providing apparatus, which is transmitted from the receiver, and transmits the received relocation-between-stations information to the content providing apparatus.

Thus, the content providing apparatus can identify the receiver that is relocated as well as the relay station in the area to which the receiver is relocated. This allows the content providing apparatus to include: a reception unit operable to receive the relocation-between-stations information transmitted from the relay station; and a transmission unit operable to transmit an Entitlement Management Message (EMM) for urging the receiver to sign up for a contract with the relay station indicated by the station identifier included in the relocation-between-stations information, said receiver being indicated by the receiver identifier included in the received relocation-between-stations information.

Here, the relay station may include a station identifier transmission unit operable to transmit, to the receiver, a station identifier which self-identifies said relay station, and the receiver may further include a station identifier storage unit operable to receive the station identifier transmitted from the relay station when a power is off at the receiver, and store the received station identifier in the station identifier holding unit. Thus, it is possible for the receiver to certainly store the CATV identifier of the CATV station to which the receiver is under the contract for satellite TV subscriptions.

Also, the station identifier transmission unit may transmit the station identifier using Engineering Transport Stream (Engineering TS). Thus, a data down-loading apparatus which employs t he Engineering TS can be applied in the same way as in the case of the receiver.

Also, the receiver further includes: an IC card reading unit operable to read out an IC card identifier from a detachable IC card, and the relocation-between-stations information transmission unit transmits the relocation-between-stations information in which the IC card identifier read out by the IC card reading unit serves as the receiver identifier. Thus, the conditional access system according to the present invention can be adapted to the conditional access system using an IC card, which is a common case in digital broadcasting.

The receiver further includes a content usage history management unit operable to store, onto a detachable IC card, content usage history information indicating a content usage history of the receiver, read out the content usage history information from the IC card and transmit the read-out content usage history information to the content providing apparatus, and the relocation-between-stations information transmission unit may transmit the relocation-between-stations information when the usage history information is transmitted to the content providing apparatus.

The present invention can be realized not only as a conditional access system but also as a stand-alone component such as a content providing apparatus, a relay station and a receiver, each of which composes the conditional access system, as a method including the characteristic components in the conditional access system as steps, and as a program having a computer to execute these steps. Needless to say, it is possible to distribute the program via a recording medium such as a CD-ROM or the like and a transmission medium such as an Internet or the like.

As for further information about technical background to this application, Japanese Patent Application No. 2002-313904 filed Oct. 29, 2002, is incorporated herein by reference.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a conditional access system according to the present invention.

FIG. 2 is a flowchart showing an operation procedure of a receiver in receiving a CATV station identifier transmitted from a CATV station.

FIG. 3 is a communication sequence diagram showing an operation of the conditional access system in a case in which the receiver is relocated between the CATV stations.

FIG. 4 is a communication sequence diagram showing another operation of the conditional access system in the case in which the receiver is relocated between the CATV stations.

FIG. 5 is a block diagram showing another example for the configuration of the conditional access system according to the present invention.

FIG. 6 is a block diagram showing another example for the configuration of the conditional access system according to the present invention.

### DESCRIPTION OF THE PREFERRED EMBODIMENT(S)

The following describes in detail the embodiment of the conditional access system according to the present invention with reference to the diagrams.

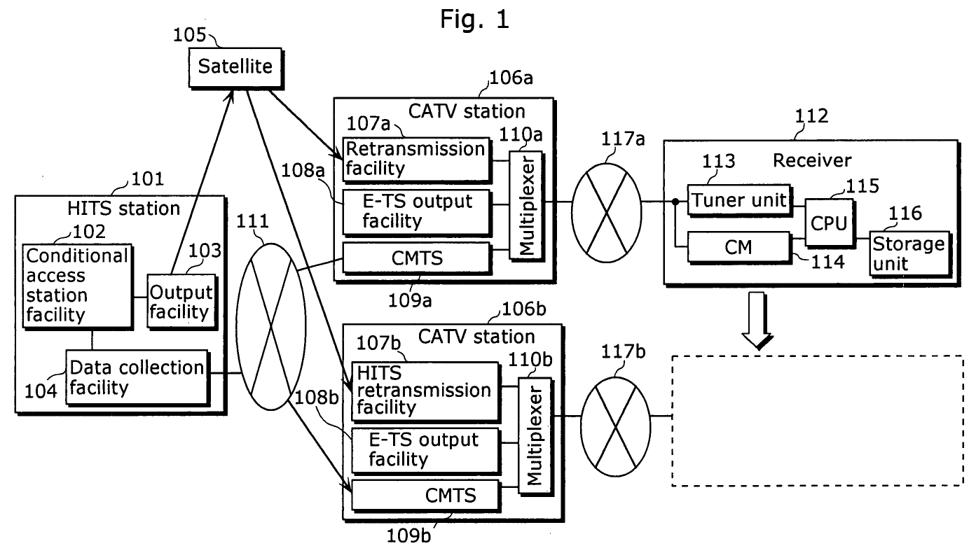

FIG. 1 is a block diagram showing a configuration of the conditional access system according to the embodiment of the present invention. The conditional access system is a system suitable for CATV in which the content provider or the CATV station can urge the user operating the receiver to sign up for satellite TV subscriptions when the receiver is relocated between the CATV stations by detecting the relocation of the receiver. The conditional access system includes a Headend In The Sky (HITS) station 101, a satellite 105, CATV stations 106a and 106b, a receiver 112, a communication network 111, cable networks 117a and 117b, and the like. In the diagram, only a single HITS station 101, two CATV stations 106a/106b and a single receiver 112 are shown for convenience, but the numbers are not limited to these.

The communication network 111 is a bi-directional communication network like a private line or an Internet for connecting the HITS station 101 and the CATV stations 106a/106b. The cable networks 117a and 117b are optical fiber cables or the like for distributing the CATV-oriented content from the CATV stations 106a and 106b to the receiver 112 as well as transmitting information from the receiver 112 to the CATV stations 106a and 106b.

The HITS station 101 is a transmission station of the content provider, that is, a broadcast station for distributing it to the CATV stations 106a and 106b via the satellite 105 by performing scramble processing on the content, and includes a conditional access station facility 102, an output facility 103 and a data collection facility 104. The conditional access station facility 102 is an encryption apparatus for performing scramble processing on the content so that only the receivers under contract for satellite TV subscriptions can receive the content, and transmits an Entitlement Management Message (EMM) which realizes the conditional access. The output facility 103 is a transmission apparatus for up-loading to the satellite 105 the content to which scramble processing is performed by the conditional access station facility 102. The data collection facility 104 is a reception apparatus for receiving and storing the information (relocation-between-stations information including an identifier of the CATV station in which the receiver is relocated and an identifier of the receiver). The relocation-between-stations information is information indicating that the receiver is moved from one CATV station to another. Here, it includes at least the identifier of the receiver and that of the CATV station.

The satellite 105 is a communication satellite for receiving the content transmitted from the HITS station 101 and broadcasting to the CATV stations 106a and 106b.

The CATV 106a is a router for receiving the content transmitted from the HITS station 101 via the satellite 105 and retransmitting it to the receiver 112 via the cable network 117a and includes a retransmission facility 107a, an Engineering-Transport Stream (Engineering-TS) output facility 108a, a Cable Modem Terminal System (CMTS) 109a and a multiplexer 110a. The retransmission facility 107a is a sender/receiver for receiving the content transmitted from the HITS station and retransmitting it to the multiplier 110a. The Engineering-TS output facility 108a stores the identifier (CATV station identifier) inside so as to identify uniquely its own station (CATV station 106a) and transmits repeatedly the CATV station identifier as Engineering TS to the multiplexer 110a. The Engineering TS is an independent data stream comprising of video streams and audio streams, which is different from a normal broadcasting stream, for the receiver to down-load data such as software or the like. The multiplexer 110a is a multiplexing and reception apparatus for multiplexing the content transmitted from the retransmission facility 107a and the CATV station identifier transmitted from the Engineering-TS output facility 108a, distributing them as a transport stream to the receiver 112 via the cable network 117a and receiving the information (relocation-between-stations information) transmitted from the receiver via the cable network 117a and transmitting it to the CMTS 109a. The CMTS 109a is a communication interface for transmitting the relocation-between-stations information transmitted from the multiplexer 110a to the HITS station 101 via the communication network 111.

The CATV station 106b is a router for receiving the content transmitted from the HITS station 101 via the satellite 105 and retransmitting it to the receiver 112 via the cable network 117a, and includes the same components as the CATV station 106a. Namely, the CATV 106b multiplexes the content transmitted from the HITS station 101 and the CATV station identifier of its own station (CATV 106b) and retransmits it to the receiver 112 via the cable network 117b. Each component 107b ˜110b making up the CATV station 106b has the same function as the components of the CATV 106a, therefore, the detailed description is abbreviated.

The receiver 112 is an apparatus for receiving the content broadcasted from the HITS station 101 via the CATV stations 106a and 106b and outputting it as video and audio signals, and includes a tuner unit 113, a cable modem unit 114, a CPU 115 and a storage unit 116. The tuner unit 113 is a tuner and decoder for selecting and receiving the content (or a program) desired by the user from a plurality of contents (or a plurality of programs) transmitted from the CATV station 106a (or the CATV station 106b), and decoding the received content into video and audio streams. The storage unit 116 is a volatile memory or the like for storing an identifier of the CATV station with which the user is under the contract for satellite TV subscriptions (the CATV station identifier of the CATV station 106a transmitted from the CATV station 106a in the diagram). The cable modem unit 114 is a communication interface for realizing a bi-directional communication between the CATV station and the receiver 112, namely, a transmission apparatus for transmitting information from the receiver 112 to the CATV station via the cable network 117a, for instance, the relocation-between-stations information including an identifier (a receiver identifier) for identifying uniquely the receiver 112 under the control of the CPU 115 and an identifier for identifying the area in which the receiver 112 is relocated (for example, a CATV station identifier of the CATV station 106b) to a new CATV station (e.g. CATV station 106b) to which the receiver 112 is connected after the relocation. The CPU 115 is a controller incorporating a program for controlling the tuner unit 113, the cable modem unit 114 and the storage unit 116.

The receiver 112 includes a conditional access processing unit that is not shown in the diagram and receives, as charged contents, only the contents for which the user has signed up. When an IC card is adopted as a conditional access processing unit, the receiver identifier mentioned above is a card ID that is attached to the IC card.

The following describes an operation of the conditional access system constructed as above.

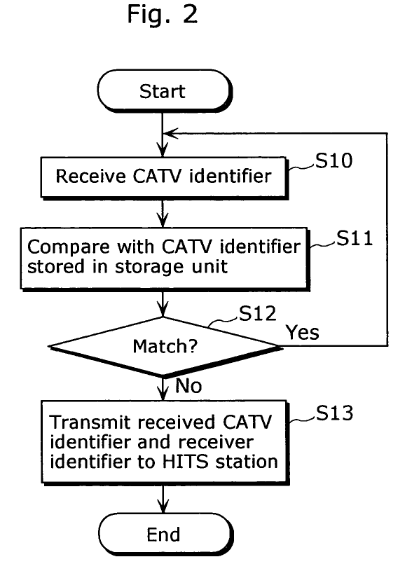

FIG. 2 is a flowchart showing an operation procedure of the receiver 112 in receiving a CATV station identifier transmitted from the CATV station, namely, a flowchart showing the operation procedure of the receiver 112 under the control of the CPU 115. Here, it is assumed that the storage unit 116 in the receiver 112 stores a CATV station identifier of the CATV station with which the user has already signed up (i.e. a CATV station before the relocation). For example, when the CATV station 106a is already in use after the sign-up for the content subscription, it is assumed that the receiver 112 receives the CATV station identifier of the CATV station 106a and stores it in the storage unit 116.

Firstly, when the tuner unit 113 receives the CATV station identifier transmitted from the CATV station 106a or 106b (S10), the receiver 112 reads out the CATV station identifier stored in the storage unit 116 and compares the two CATV identifiers (S11). When the received CATV identifier and the one stored in the storage unit 116 matches (Yes in S12), the receiver 112 judges that no relocation between CATV stations has taken place and repeats the same processing without any special processing (S10˜S12). When the two identifiers match (No in S12), the receiver 112 judges that a relocation between stations has taken place and transmits the relocation-between-stations information including the received CATV station identifier and its own receiving identifier to the CATV station 106a or the CATV station 106b (S13). In this case, the receiver 112 transmits the relocation-between-stations information to either CATV station 106a or 106b addressed to a destination indicated in the identifier identifying the HITS station 101 included in the EMM transmitted from the conditional access station facility 102 at the HITS station 101.

After that, the relocation-between-stations information transmitted from the receiver 112 is transmitted from the CATV station 106a or 106b to the HITS station 101 (the data collection facility 104 at the HITS station 101) via the communication network 111. Therefore, the data collection facility 104 at the HITS station 101 which has received the relocation-between-stations information can tell that the receiver 112 is relocated between the CATV stations, that is, which receiver 112 is relocated to which CATV station, based on the two identifiers (a CATV station identifier and a receiver identifier) included in the relocation-between-stations information. Consequently, it is possible to urge a receiver which has been relocated to sign up, for instance, when the HITS station 101 transmits the message that is prepared beforehand for each CATV station identifier collected by the data collection facility 104 as an EMM to the receiver 112 using the conditional access station facility 102, while the receiver 112 displays the received message, for example, “Please call the CATV station (XXX-XXXX) for a content subscription” on the TV monitor so that the receiver can read it. The subscription is further promoted when it is not the CATV station in the area to which the receiver 112 is relocated that completely inhibits the receiver 112 to receive the content, but it is the HITS station 101 that broadcasts to the receiver 112 with limitation using the conditional access station facility 102, namely, to allow the use of content with limitation.

As for the timing at which the receiver 112 transmits the relocation-between-stations information addressed to the HITS station 101 to the CATV station, it may be at the same time when a history of PPV (Pay Per View) is up-loaded to the HITS station 101. For example, when the receiver has a function to store, on a detachable IC card, content usage history information indicating a history of content used by the receiver as well as to read out the content usage history information from the IC card so as to transmit it to the HITS station 101, the receiver may transmit the relocation-between-stations information at the same time when transmitting content usage history information to the HITS station 101. In this case, the data collection facility 104 at the HITS station functions also as a PPV history collection apparatus.

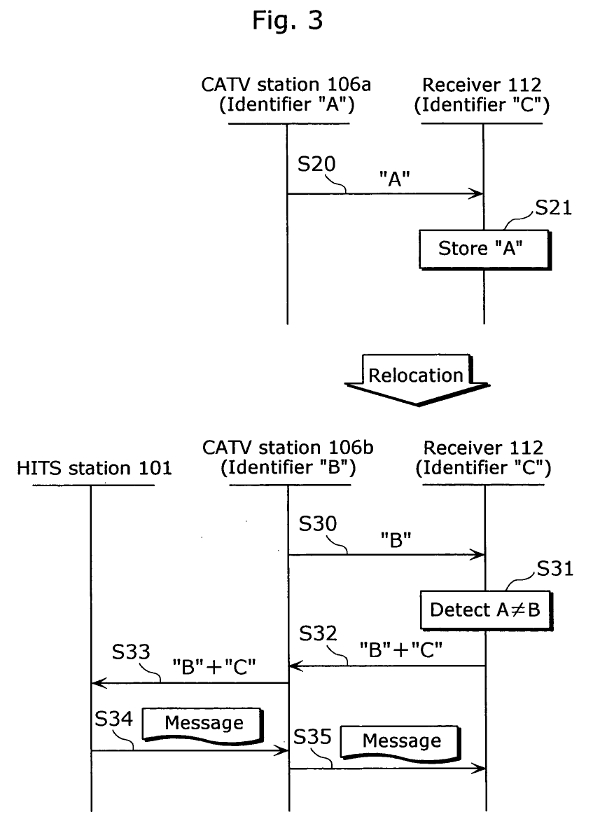

FIG. 3 is a communication sequence diagram showing an operation (an operation focusing mainly on a transmission/reception of various identifiers) of the conditional access system when the receiver 112 is relocated from the CATV station 106a to the CATV station 106b. Here, the CATV station identifier of the CATV 106a is represented by “A”, the CATV station identifier of the CATV station 106b is represented by “B” and the receiver identifier of the receiver 112 is represented by “C”.

As shown in the upper part of FIG. 3, the receiver 112 receives the CATV station identifier “A” transmitted from the CATV station 106a using Engineering-TS (S20) and stores it in the storage unit 116 (S21), when the receiver 112 is connected to the CATV station 106a with which the receiver is under the contract for TV subscriptions.

As shown in the lower part of FIG. 3, assume that the receiver 112 is relocated from the operation area of the CATV station 106a to the operation area of the CATV station 106b, the receiver 112 receives the CATV station identifier “B” transmitted using Engineering-TS from the CATV station 106b (S30). Therefore, by comparing the received CATV station identifier “B” and the CATV station identifier “A” stored in the storage unit 116, the receiver detects that these identifiers do not match (S31). The receiver 112 then transmits, to the CATV station 106b, the relocation-between-stations information including the received CATV station identifier “B” and its own identifier (the receiver identifier “C”), as data addressed to the HITS station 101 (S32).

The relocation-between-stations information transmitted from the receiver 112 is transferred to the HITS station 101 via the CATV station 106b (S33) so that the HITS station 101 knows that the receiver 112 identified by the receiver identifier “C” is relocated to the CATV station 106b. The HITS station 101 transmits to the receiver 112 identified by the receiver identifier “C” a message aiming to urge the receiver 112 to sign up with the CATV station 106b either by sending the EMM (S35) or by broadcasting the content with usage limitation to the receiver 112, or informs the CATV station 106b, via the communication network 111, of the fact that the receiver 112 is relocated.

Thus, the receiver 112 which has just been relocated is encouraged to sign up with the CATV station 106b in the area to which the receiver 112 is relocated, which is different from the prevention of unauthorized relocation using the existing usage control system for transmodulation.

As described above, the conditional access system according to the present invention is described based on the embodiment, however, the present invention is not limited to this embodiment.

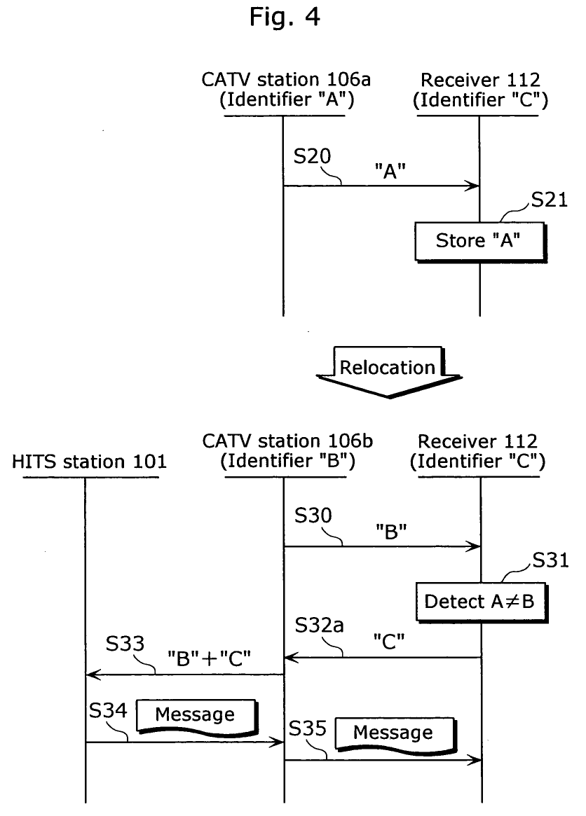

For example, the receiver 112 after the relocation transmits the CATV station identifier and the receiver identifier to the CATV station, when the received CATV station identifier and the stored CATV station identifier do not match, however, only the receiver identifier may be transmitted (S32a) as in the example of the communication sequence shown in FIG. 4. The relocation-between-stations information received by the HITS station 101 will be the same when the CATV station, having received the receiver identifier, transmits to the HITS station 101 the receiver identifier together with its own CATV station identifier as relocation-between-stations information (S33).

In the present embodiment, the relocation-between-stations information includes both the receiver identifier and the CATV station identifier. The relocation-between-stations information, however, shall not be limited to the information as such. For example, information including a CATV identifier stored in the storage unit 116 of the receiver (i.e. a CATV station identifier of the CATV station to which the receiver was subscribing before the relocation) or date and hour of the relocation, and the like may be included in addition to these identifiers. Thus, various services and correspondences directed to the receiver, the CATV station, or the like can be realized by the HITS station 101 which has obtained such relocation-between-stations information.

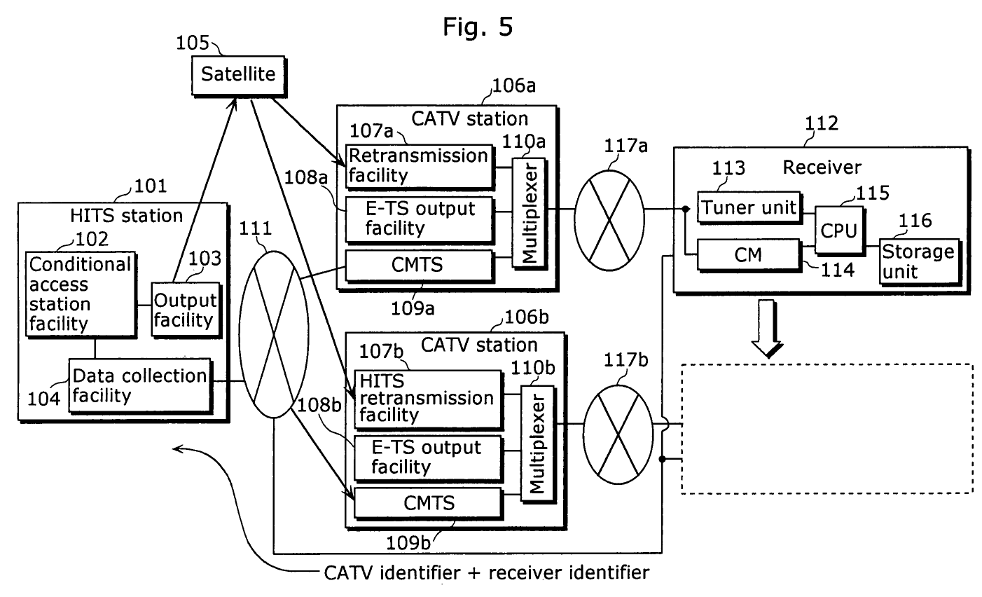

In the present embodiment, the relocation-between-stations information transmitted by the receiver 112 is transferred to the HITS station via the CATV station. It may be, however, transmitted directly from the receiver 112 to the HITS station 10, as shown in the example of a system configuration shown in FIG. 5. This can be realized, for example, when the receiver 112 and the HITS station 101 are connected via a communication network such as Internet or via the cable networks 117a and 117b. Consequently, it is possible to provide the CATV station with the relocation information inaccessible to the CATV station.

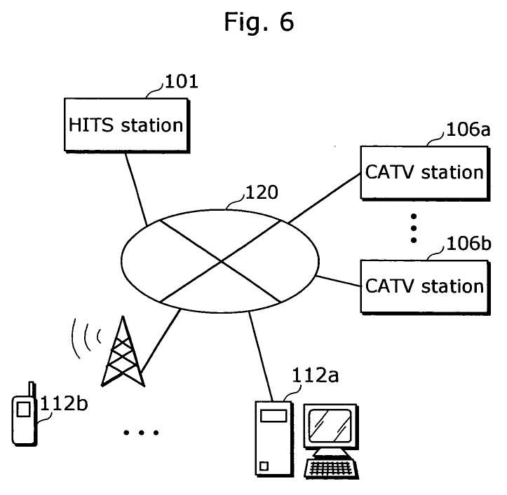

In the present embodiment, the HITS station 101 and the CATV stations 106a and 106b are connected through one-directional satellite communication via satellite 105, however, they may be connected via bi-directional communication such as a terrestrial communication. For example, the HITS station 101, the CATV stations 106a/106b and the receivers 112a/112b may be connected via the Internet 120, as in the example of system configuration shown in FIG. 6. In this case, the content distribution from the HITS station 101 addressed to the receivers 112a/112b and the data transmission of the relocation-between-stations information from the receiver 112a/112b addressed to the CATV stations 106a/106b and the HITS station 101 are operated via the Internet.

In the present embodiment, the receiver 112 is described as a TV tuner for receiving the broadcasts and outputting the video signals on the TV monitor. The present invention, however, is not limited to such receiver, and may be a PDA (Personal Digital Assistant) such as a cell phone or the like for receiving and replaying music contents or video contents.

In the present embodiment, the CATV stations 106a and 106b transmit the CATV station identifier using Engineering-TS. The CATV station identifier may be transmitted using other transmission method different from the Engineering-TS, for instance, a transmission using a frequency band different from the one used for ordinary broadcasting or using a different modulation method.

Thus, with the use of the conditional access system according to the present invention, it is possible for the content provider to know the receiver that is relocated between the CATV stations without authorization as well as the CATV station in the area to which the receiver is relocated. Furthermore, the message which urges the receiver to sign up for satellite TV subscriptions is displayed, therefore, the promotion of the content subscription in the area to which the receiver is relocated can be expected and the receiver can get information on the correspondence of the CATV station.

What is claimed is:

1. A conditional access system comprising:
a content providing apparatus for transmitting a content to which only a receiver under contract for satellite TV subscriptions can have an access;
a plurality of relay stations for receiving and retransmitting the content transmitted from the content providing apparatus; and
a receiver for receiving the content retransmitted from one of the plurality of relay stations, wherein the receiver includes:
a station identifier holding unit operable to hold a station identifier for identifying the relay station with which the receiver is under the contract for satellite TV subscriptions;
a station identifier reception unit operable to receive a station identifier transmitted from the relay station;
a judgment unit operable to judge whether or not the received station identifier and the station identifier held in the station identifier holding unit match; and
a relocation-between-stations information transmission unit operable to transmit relocation-between-stations information to the content providing apparatus, when the judgment unit judges that the received station identifier and the station identifier held in the station identifier holding unit do not match, said relocation-between-stations information including a receiver identifier which identifies the receiver.

2. The conditional access system according to claim 1,
wherein the relocation-between-stations information transmission unit transmits the relocation-between-stations information to the content providing apparatus, said relocation-between-stations information including, in addition to the receiver identifier, the station identifier received by the station identifier reception unit.

3. The conditional access system according to claim 2,
wherein the relocation-between-stations information transmission unit transmits the relocation-between-stations information addressed to the content providing apparatus to the relay station from which the station identifier has been transmitted, and
the relay s tation receives the relocation-between-stations information addressed to the content providing apparatus, which is transmitted from the receiver, and transmits the received relocation-between-stations information to the content providing apparatus.

4. The conditional access system according to claim 3,
wherein the content providing apparatus includes:
a reception unit operable to receive the relocation-between-stations information transmitted from the relay station; and
a message transmission unit operable to transmit an Entitlement Management Message (EMM) for urging the receiver to sign up for a contract with the relay station indicated by the station identifier included in the relocation-between-stations information, said receiver being indicated by the receiver identifier included in the received relocation-between-stations information.

5. The conditional access system according to claim 3.
wherein the content providing apparatus includes:
a reception unit operable to receive the relocation-between-stations information transmitted from the relay station; and
a usage control unit operable to transmit a content with limited usage to the receiver indicated by the receiver identifier included in the received relocation-between-stations information.

6. The conditional access system according to claim 1,
wherein the relay station includes a station identifier transmission unit operable to transmit, to the receiver, a station identifier which self-identifies said relay station, and
the receiver further includes a station identifier storage unit operable to receive the station identifier transmitted from the relay station when a power is off at the receiver, and store the received station identifier in the station identifier holding unit.

7. The conditional access system according to claim 6,
wherein the station identifier transmission unit transmits the station identifier using Engineering Transport Stream (Engineering-TS).

8. The conditional access system according to claim 1,
wherein the receiver further includes an IC card reading unit operable to read out an IC card identifier from a detachable IC card, and
the relocation-between-stations information transmission unit transmits the relocation-between-stations information in which the IC card identifier read out by the IC card reading unit serves as the receiver identifier.

9. The conditional access system according to claim 1,
wherein the receiver further includes a content usage history management unit operable to store, onto a detachable IC card, content usage history information indicating a content usage history of the receiver, read out the content usage history information from the IC card, and transmit the read-out content usage history information to the content providing apparatus, and
the relocation-between-stations information transmission unit transmits the relocation-between-stations information when the usage history information is transmitted to the content providing apparatus.

10. The conditional access according to claim 1,
wherein the relocation-between-stations information transmission unit transmits the relocation-between-stations information with an address indicated in an identifier of the content providing apparatus, which is notified in advance by the content providing apparatus using EMM.

11. The conditional access system according to claim 1,
wherein the relocation-between-stations information transmission unit transmits the relocation-between-stations information addressed to the content providing apparatus to the relay station from which the station identifier has been transmitted, and
the relay station transmits information including the relocation-between-stations information transmitted from the receiver and a self-identifying station identifier for identifying said relay station, as new relocation-between-stations information.

12. The conditional access system according to claim 1,
wherein the content providing apparatus is a Headend In The Sky (HITS) station for distributing the content to the plurality of the relay stations using a satellite communication, and
each of the relay stations is a CATV station for retransmitting the content distributed from the content providing apparatus to the receiver via a cable.

13. The conditional access system according to claim 12,
wherein the relocation-between-stations information transmission unit transmits the relocation-between-stations information addressed to the content providing apparatus to the relay station via the cable, and
the relay station transmits the relocation-between-stations information addressed to the content providing apparatus, which is transmitted from the receiver, to the content providing apparatus via a bi-directional communication network.

14. A receiver in a conditional access system comprising:
a content providing apparatus for transmitting a content to which only a receiver under contract for satellite TV subscriptions can have an access;
a plurality of relay stations for receiving and retransmitting the content transmitted from the content providing apparatus; and
a receiver for receiving the content retransmitted from one of the plurality of relay stations,
wherein the receiver includes:
a station identifier holding unit operable to hold a station identifier for identifying the relay station with which the receiver is under the contract for satellite TV subscriptions;
a station identifier reception unit operable to receive a station identifier transmitted from the relay station;
a judgment unit operable to judge whether or not the received station identifier and the station identifier held in the station identifier holding unit match; and
a relocation-between-stations information transmission unit for transmitting relocation-between-stations information to the content providing apparatus, when the judgment unit judges that the received station identifier and the station identifier held in the station identifier holding unit do not match, said relocation-between-stations information including a receiver identifier which identifies the receiver.

15. The receiver according to claim 14,
wherein the relocation-between-stations information transmission unit transmits the relocation-between-stations information to the content providing apparatus, said relocation-between-stations information including, in addition to the receiver identifier, the station identifier received by the station identifier reception unit.

16. The receiver according to claim 15,
wherein the relocation-between-stations information transmission unit transmits the relocation-between-stations information addressed to the content providing apparatus to the relay station from which the station identifier has been transmitted, and
the relay station receives the relocation-between-stations information addressed to the content providing apparatus, which is transmitted from the receiver, and transmits the received relocation-between-stations information to the content providing apparatus.

17. The receiver according to claim 14,
wherein the relay station includes a station identifier transmission unit operable to transmit a station identifier which self-identifies said relay station, and
the receiver further includes a station identifier storage unit operable to receive the station identifier transmitted from the relay station when a power is off at the receiver, and store the received station identifier in the station identifier holding unit.

18. The receiver according to claim 14,
wherein the receiver further includes an IC card reading unit operable to read out an IC card identifier from a detachable IC card, and
the relocation-between-stations information transmission unit transmits the relocation-between-stations information in which the IC card identifier read out by the IC card reading unit serves as the receiver identifier.

19. The receiver according to claim 14,
wherein the receiver further includes a content usage history management unit operable to store, onto a detachable IC card, a history of content used by the receiver, read out the content usage history information from the IC card and transmit the read-out content usage history information to the content providing apparatus, and
the relocation-between-stations information transmission unit transmits the relocation-between-stations information when the content usage history information is transmitted to the content providing apparatus.

20. The receiver according to claim 14,
wherein the relocation-between-stations information transmission unit transmits the relocation-between-stations information with an address indicated in an identifier of the content providing apparatus, which is notified in advance by the content providing apparatus using EMM.

21. A relocation-between-stations management method for managing a relocation of a receiver between stations in a conditional access system comprising:
a content providing apparatus for transmitting a content to which only a receiver under contract for satellite TV subscriptions can have an access;
a plurality of relay stations for receiving and retransmitting the content transmitted from the content providing apparatus; and
a receiver for receiving the content retransmitted from one of the relay stations,
wherein the receiver includes:
a station identifier holding unit operable to hold a station identifier for identifying the relay station with which the receiver is under the contract for satellite TV subscriptions,
the relocation-between-stations management method includes:
a station identifier reception step of receiving a station identifier transmitted from the relay station;
a judgment step of judging whether or not the received station identifier and the station identifier held in the station identifier holding unit match; and
a relocation-between-stations information transmission step of transmitting relocation-between-stations information to the content providing apparatus, when it is judged that the received station identifier and the station identifier held in the station identifier holding unit do not match, said relocation-between-stations information including a receiver identifier which identifies the receiver.

22. A program for managing a relocation of a receiver between stations in a conditional access system comprising:
a content providing apparatus for transmitting a content to which only a receiver under contract for satellite TV subscriptions can have an access;
a plurality of relay stations for receiving and retransmitting the content transmitted from the content providing apparatus; and
a receiver for receiving the content retransmitted from one of the relay stations, wherein the receiver includes a station identifier holding unit operable to hold a station identifier for identifying the relay station with which the receiver is under the contract for satellite TV subscriptions, and
the program includes:
a station identifier reception step of receiving a station identifier transmitted from the relay station;
a judgment step of judging whether or not the received station identifier and the station identifier held in the station identifier holding unit match;
a relocation-between-stations information transmission step of transmitting relocation-between-stations information to the content providing apparatus, said relocation-between-stations information including a receiver identifier which identifies the receiver.
